(19) United States
(12) Patent Application Publication
(10) Pub. No.: US 2008/0090611 A1
(43) Pub. Date: Apr. 17, 2008

(54) System and Method for Information Handling System Modular Wireless Integration

(76) Inventors: Pratik M. Mehta, Austin, TX (US); Alan E. Sicher, Austin, TX (US); Charles D. Hood, Cedar Park, TX (US); Dennis Burrell, Round Rock, TX (US)

Correspondence Address: HAMILTON & TERRILE, LLP, P.O. BOX 203518, AUSTIN, TX, 78720, US

(21) Appl. No.: 11/549,684

(22) Filed: Oct. 16, 2006

(51) Int. Cl. H04B 1/38; H04M 1/00

(52) U.S. Cl. 455/557

(57) ABSTRACT

Wireless functionality is provided to desktop information handling systems by a module sized to fit as a storage drive bay component, such as a flexbay. The wireless functionality includes wireless personal area networking that supports peripherals, such as Ultra-Wideband or Bluetooth devices, or local area networking. An antenna for wireless processing components is disposed at the front portion of the module to provide optimal reception. A standardized information handling system interface is disposed at the rear of the module located to connect with the information handling system chassis. Additional functionality may alternatively be included in the module, such as a 12-in 1 card reader having interfaces at the front of the module to interact with memory cards or other devices.

### BACKGROUND OF THE INVENTION

1. Field of the Invention

The present invention relates in general to the field of information handling system modular construction, and more particularly to a system and method for information handling system modular wireless integration.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems are generally built from a variety of hardware components. Portable information handling systems tend to have a tighter integration of components than desktop information handling systems since portable systems are built in housings having a more restricted size. In contrast, desktop information handling systems tend to have a modular construction that allows easier insertion and removal of components within the housing. For example, slots interfaced with the system motherboard accept components as daughterboard cards and drive bays typically exposed at the front of the system accept memory drives, such as optical drives and hard drives. Often, a smaller-sized bay, called a “flexbay,” is included among the drive bays, the flexbay sized to accept a 3.5 inch floppy disk drive, which is only rarely included in current desktop systems. End users often integrate new drives into a desktop information handling systems by removing a cover placed over the drive bay, connecting the drive to a bus available within the drive bay, inserting the drive into the bay and securing the drive to the information handling system chassis.

Portable information handling systems have an advantage over desktop systems since portable systems are easily transported while operating with an internal power supply. This advantage is further enhanced by wireless networking integrated into most portable information handling systems, which allows users to access the Internet without a physical network connection. In contrast, desktop information handling systems typically have a physical power connection, a physical network connection and a variety of physical peripheral connections, such as a keyboard, a mouse, a display, one or more speakers, a printer and other types of devices. The physical connections to a desktop information handling system are often an unsightly tangle that makes desktop systems difficult to set up and move. In response, manufacturers have attempted to apply wireless networking techniques to desktop information handling systems. For example, a wireless personal area network (WPAN) proposes to interface many peripherals through a locally-supported network architecture, such as with Bluetooth or Ultra-Wideband (UWB) 802.11(a) networking. As another example, instead of using Ethernet cables to form a local area network, end users interface desktop information handling systems to a wireless network with a wireless access point (WAP), such as with the 802.11 (b), (g) or (n) standards. However, desktop wireless solutions are challenged by the impact of wireless transceiver placement on wireless radio performance. Desktop systems do not typically have wireless integration hooks built into the chassis for antenna/wireless solutions, which increases the cost and impacts the performance of creating a wireless solution for a desktop system.

### SUMMARY OF THE INVENTION

Therefore a need has arisen for a system and method which provides modular integration of wireless networking into a desktop information handling system.

In accordance with the present invention, a system and method are provided which substantially reduce the disadvantages and problems associated with previous methods and systems for integration of wireless networking into a desktop information handling system. Wireless functionality is integrated into a module having the form factor of a storage drive device to fit into a desktop information handling system storage drive bay. The wireless module couples in a manner similar to a storage drive to provide modular wireless functionality for the desktop information handling system.

More specifically, a desktop information handling system has plural processing components disposed in a chassis. The chassis includes storage drive bays sized to accept storage drives, such as optical drives, hard drives, or, in a flexbay, 3.5 inch floppy drives. A wireless module having the form factor of a storage drive fits in the storage drive bays of the desktop information handling system to provide wireless functionality, such as WPAN or WLAN capabilities. An antenna at the front of the wireless module improves wireless transceiver reception and transmission and, in one embodiment, is hidden from view by a non-shielding plastic cover. In addition to wireless functionality, the wireless module may include a 12-in-1 card reader to interact with a variety of memory cards, and may include a USB hub to support multiple USB interface ports. Communication between the wireless module and information handling system components is provided through one or more connectors aligned at the rear of the wireless module. The connectors electrically connect with connectors of the desktop information handling system during insertion of the wireless module to the information handling system.

The present invention provides a number of important technical advantages. One example of an important technical advantage is that a wireless networking bay module integrates into a desktop information handling system to provide a modular solution for wireless networking. Wireless performance characteristics are enhanced by the disposition of antennae in the module and design of the module chassis for integration with the information handling system. Other types of devices are optionally included in the module, such as a 12-in-1 card reader, to enhance wireless networking functions. WPAN functions supported from a flexbay have improved radio transceiver reception to support peripheral functions and are integrated as an add-on feature by insertion of a wireless module into the flexbay.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a side cutaway block diagram of a desktop information handling system having modular wireless functionality;

FIG. 2 depicts an upper perspective view of one example embodiment of a wireless module sized to fit in a desktop information handling system storage drive bay;

FIG. 3 depicts a lower perspective view of one example embodiment of a wireless module sized to fit in a desktop information handling system storage drive bay and having USB support; and

FIG. 4 depicts an upper perspective view of one example embodiment of a wireless module sized to fit in a desktop information handling system storage drive bay and having USB and card reader support.

### DETAILED DESCRIPTION

A wireless module sized to fit in a desktop information handling system storage drive bay provides wireless functionality with a modular component having a form factor that fits into the desktop information handling system as a storage drive would fit. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

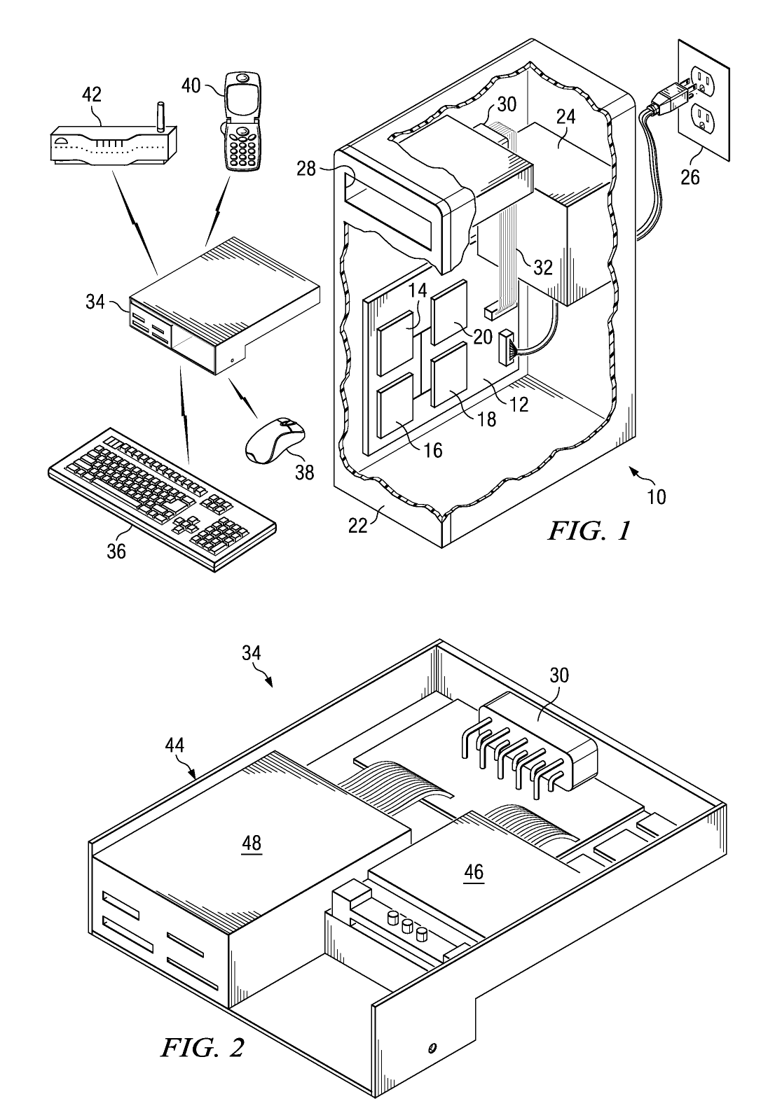

Referring now to FIG. 1, a side cutaway block diagram depicts a desktop information handling system 10 having modular wireless functionality. Desktop information handling system 10 processes information with a plurality of processing components, such as motherboard 12 supporting a CPU 14, RAM 16, a hard disk drive 18 and a chipset 20. The processing components are disposed in a chassis 22 and supported by a power supply 24 that operates with power provided from an external power source 26, such as an external AC socket. Information handling system chassis 22 has one or more storage device bays 28 that accept storage devices, such as optical drives, hard disk drives and, for flexbays, 3.5 inch magnetic drives. Chassis 22 includes a storage device bay connector 30 that interfaces with the processing components through a cable 32, such as an SCSI, USB, or PCI Express cable. Storage devices are built with a form factor that allows a user to insert a storage device into bay 28 aligned for electrical communication with connector 30 and couple the storage device to chassis 22. A wireless module 34 having components to support wireless functionality has the form factor of a storage device so that wireless module 34 fits into storage device bay 28 as a storage device would. Once coupled to chassis 22 and in electrical communication with a connector 30, wireless module 34 interfaces with the processing components to provide desktop information handling system 10 wireless functionality, such as a wireless personal area network (WPAN) for peripherals, like a keyboard 36, mouse 38 or camera phone 40. Alternatively, wireless module 34 provides wireless local area networking through a wireless access point 42.

Referring now to FIG. 2, an upper perspective view depicts one example embodiment of a wireless module 34 sized to fit in a desktop information handling system storage drive bay. Wireless module 34 is built in a chassis 44 having a form factor that provides compatibility with a storage drive that fits into a storage drive bay. Wireless module chassis 36 contains one or more wireless processing components 36 that support wireless functionality, such as a WPAN card or a wireless network interface card for interfacing with a WLAN. Wireless processing component interfaces with the processing components of desktop information handling system 10 through, for instance, a connector 30 aligned to couple with a connector of information handling system 10. In addition, other types of devices may be included in chassis 44, such as a 12-in-1 card reader 48 that interfaces with variety of storage card devices or a WPAN card. Information handling system connector 30 manages communication for multiple devices through a single or multiple connections, essentially altering the 12-in-1 card reader to perform as a 14-in-1 reader having WPAN and WLAN capabilities.

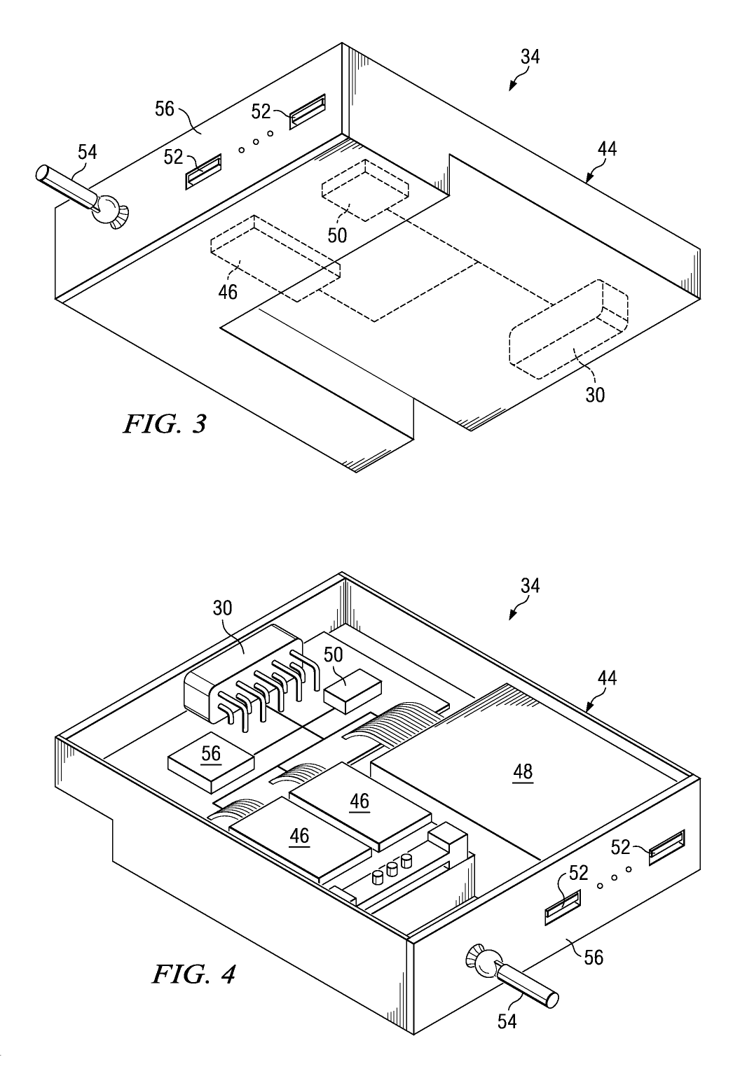

Referring now to FIG. 3, a lower perspective view depicts one example embodiment of a wireless module 34 sized to fit in a desktop information handling system storage drive bay 28 and having USB support. Wireless module chassis 44 supports wireless processing component 46 and a USB hub 50. USB hub 50 provides plural USB interface ports at the front portion of chassis 44 so that, when chassis 44 is coupled into a storage drive bay, USB interface ports 52 are exposed at the front surface of information handling system 10. An antenna 54 supports the operation of one or more transceivers of wireless processing components and is embedded behind a nonconductive portion of cover 56 so that reception and transmission of radio signals is not impeded. Location of antenna 54 at cover 56 provides improved reception and transmission of radio signals where wireless module 34 inserts into the front portion of information handling system 10.

Referring now to FIG. 4, an upper perspective view depicts one example embodiment of a wireless module sized to fit in a desktop information handling system storage drive bay and having USB and card reader support. Wireless chassis 44 is sized to fit in a flexbay, such as by adopting the form factor of a 3.5 inch floppy disk drive. A first wireless processing component 46 provides support for WPAN, such as Bluetooth or UWB, and a second wireless processing component 46 provides support for WLAN, such as 802.11 (b), (g) or (n). A common antenna 54 extends out from chassis 44 to allow user adjustments to its position. In alternative embodiments, separate antennas or multiple common antennas may be used at various locations on the information handling system. Connector 30 interfaces with wireless processing components 46 to support communication with information handling system processing components. Alternative bus links are available by connecting through USB hub 50 or with a PCI Express controller 56. Communications for wireless processing components 46 and 12-in-1 card reader 48 may be multiplexed through a common link, such as a USB or PCI Express link, or sent through separate connections at various locations.

Although the present invention has been described in detail, it should be understood that various changes, substitutions and alterations can be made hereto without departing from the spirit and scope of the invention as defined by the appended claims.

What is claimed is:

1. An information handling system comprising:
a chassis;
plural processing components disposed in the chassis and operable to process information;
at least one drive bay disposed in the chassis, the drive bay operable to support a drive;
a link associated with the drive bay, the link interfaced with the processing components and operable to communicate information between the processing components and the drive bay; and
a wireless module sized to fit in the drive bay, the wireless module having wireless processing components operable to interface with the link to provide wireless functionality to the processing components.

2. The information handling system of claim 1 further comprising a card reader integrated in the wireless module and interfaced with the link, the card reader operable to interface memory with the processing components.

3. The information handling system of claim 1 wherein the wireless functionality comprises a wireless personal area network operable to interface the processing components with peripherals.

4. The information handling system of claim 3 wherein the wireless personal area network comprises Bluetooth.

5. The information handling system of claim 3 wherein the wireless personal area network comprises Ultra-Wideband.

6. The information handling system of claim 1 wherein the wireless functionality comprises a local area network interface.

7. The information handling system of claim 1 wherein the link comprises a PCI Express link.

8. The information handling system of claim 1 wherein the link comprises a USB link and wherein the wireless module comprises a USB hub operable to provide plural USB links at the wireless module.

9. The information handling system of claim 1 wherein the drive bay comprises a flexbay.

10. A method for integrating wireless functionality into a desktop information handling system, the method comprising:
forming at least one storage drive bay in the desktop information handling system;
integrating the wireless functionality into a module sized to fit in the storage drive bay;
interfacing the wireless functionality of the module with the desktop information handling system through the storage drive bay; and
coupling the module into the storage drive bay.

11. The method of claim 10 wherein the wireless functionality comprises a wireless personal area network.

12. The method of claim 10 wherein integrating the wireless functionality comprises integrating a wireless antenna in a front portion of the module, the front portion coupling to a front portion of the drive bay.

13. The method of claim 10 further comprising:
integrating a card reader into the module; and
interfacing the card reader of the module with the desktop information handling system through the storage drive bay.

14. The method of claim 10 wherein interfacing the wireless functionality of the module with the desktop information handling system further comprises interfacing through a PCI Express link.

15. The method of claim 10 wherein interfacing the wireless functionality of the module with the desktop information handling system further comprises interfacing through a USB hub.

16. A module for providing wireless functionality to a desktop information handling system, the module comprising:
a module chassis sized to fit into a desktop information handling system storage drive bay, the module chassis having a front and a rear;
a connector coupled to the module chassis rear and operable to electronically interface with a connector coupled to the desktop information handling system;
a wireless networking processing component disposed in the module chassis and interfaced with the connector, the wireless networking processing component operable to provide wireless functionality to the desktop information handling system; and
an antenna disposed in the module chassis front and interfaced with the wireless networking processing component.

17. The module of claim 16 wherein the wireless networking processing component comprises a wide area networking component operable to interface peripherals with the desktop information handling system.

18. The module of claim 16 wherein the connector comprises a PCI Express link.

19. The module of claim 16 wherein the module chassis is sized to fit in a flexbay.

20. The module of claim 16 further comprising a card reader interfaced with the connector and operable to read memory cards inserted at the front of the module chassis.
